(19) United States
(12) Patent Application Publication
(10) Pub. No.: US 2011/0047203 A1
(43) Pub. Date: Feb. 24, 2011

(54) Content Aware Augmented Transform and Transfer Organizer (CAATTO)

(76) Inventor: Marc J. Parmet, Camarillo, CA (US)

Correspondence Address: Energics Inc., 5321 San Francesca Drive, Camarillo, CA, 93012, US

(21) Appl. No.: 12/859,761

(22) Filed: Aug. 19, 2010

Related U.S. Application Data
(60) Provisional application No. 61/235,436, filed on Aug. 20, 2009.

(51) Int. Cl. G06F 15/16

(52) U.S. Cl. 709/201

(57) ABSTRACT

This unique smart grid invention is an event-driven, highly flexible and configurable dynamic messaging data processing engine for either smart micro- &/or macro-grid energy environments, with the means to enable identification of only desired content from text and rich media data sources, intelligently filter out unwanted content, and deliver according to intelligent contextual relevance—all based upon human interaction with energy management.

With an ever-increasing need to intelligently organize messages (voice, email, text, graphics) and filter out unwanted content, this solution provides the advantage of an exponential smart grid capability, by enabling the means to intelligently identify, process, and deliver contextually relevant messaging based upon users' interaction with energy management. This invention provides a practical and readily available means to seamlessly integrate energy use with intelligence-driven contextually relevant message delivery via a common delivery channel—enabling content aggregation, augmentation, and transformation into a concerted and organized presentation.

### CROSS-REFERENCED TO RELATED APPLICATION

This Application claims priority to Provisional Application No. 61/235,436 Filed: Aug. 20, 2009 “Content Aware Augmented Transform and Transfer Organizer (CAATTO).”

### BACKGROUND OF THE INVENTION

1. Field of the Invention

The field of this invention is data processing, or more specifically, methods, apparatus, and products for the unique intelligent generation, management, storage and distribution of power, and related data. This invention provides a practical and readily available means to enable only the delivery of desired content from text and rich media data sources, schedule specifically to be delivered when desired, and intelligently filter out unwanted content—all defined by intelligent contextual relevance, and driven by human interaction with energy management. This smart grid invention can be easily adopted and readily used by consumers.

2. Description of Related Art

The current industry that supports power generation and distribution is driven by brute force electric connectivity switching across a grid of physical structures that have been part of the public utilities infrastructure for decades. As advances in the thinking of power generation, management, storage, and distribution processing have lead to the consideration of more efficient means to measure and manage services to the public domain, the industry is also faced with the ever-expanding power demands of their supported markets, and, more specifically, how to enable capabilities for providing intelligence-driven messaging solutions based upon human interaction with energy management.

With the advent of the SMART Grid, the integration of bridging vendor-specific physical monitoring devices' capabilities to also connect to a background proprietary network connection has enabled communication between available network segments where connectivity is available. While limited by adopted standards, there hasn't been a business motivation to open up the network to share the wealth of information outside the control of the utilities' domain—let alone the capability for providing dynamic intelligence to enable a messaging model based upon contextual relevance.

Under tight market controls, very little advancement has been made in the utility industry. As a legalized oligopoly with the rights to distribute power without area competition, there has not been a business reason for the power utility industry to modernize their business model to enable outside integration. Today, there exists no alternative for a response to a network event—within either a micro-grid or integrated into existing power macro-grids—with the capability to dynamically enable and deliver an efficient intelligence-based messaging model driven by contextual relevance.

### SUMMARY OF THE INVENTION

This invention is an event-driven, highly flexible and configurable dynamic messaging data processing engine for either smart micro- &/or macro-grid energy environments, with the means to enable the delivery of only desired content from text and rich media data sources, scheduled specifically to be delivered when desired, and intelligently filters out unwanted content—all based upon human interaction with energy management, and driven by intelligent contextual relevance.

This invention provides a powerful utility service design that minimizes the amount of storage required for persisting messages, filters out unwanted messages, organizes text, email, and voice mail messages into a common delivery channel, enabling content aggregation, augmentation, and transformation into a concerted and organized presentation, and seamlessly integrate energy use with intelligence-driven contextually relevant message delivery via a common delivery channel—enabling content aggregation, augmentation, and transformation into a concerted and organized presentation.

There is a large need to intelligently organize messages (voice, email, text, graphics), filter out unwanted content, and, based upon human interaction with energy management, intelligently deliver contextually relevant message content on demand.

Mailboxes are inundated with unwanted email, voice, text, and graphic messages, and in the process, dramatically reduce the allocated amount of available message storage capacity. This continuous assault of inquiries and messages increases the amount of time required to manually sort though unwanted content, in order to identify and absorb only those messages which hold meaningful and relevant content. Additionally, message content is not organized, nor is its delivery coordinated according to the users' energy-based locale or when the user wants to consume its content. This invention delivers the dynamic and intelligent means for enabling a contextually relevant messaging delivery model based upon human interaction with energy management, and can therefore be leveraged across the smart micro- or macro-grid.

There is a need to provide users of the smart grid with this very powerful service option, especially ones that lack data integration capabilities for integrating information exchange processes to provide dynamic messaging solutions based upon contextual relevance. This invention offers an exponential capability to the grid, by enabling the means to intelligently process and deliver contextually relevant messaging based upon the consumers' interaction with energy management.

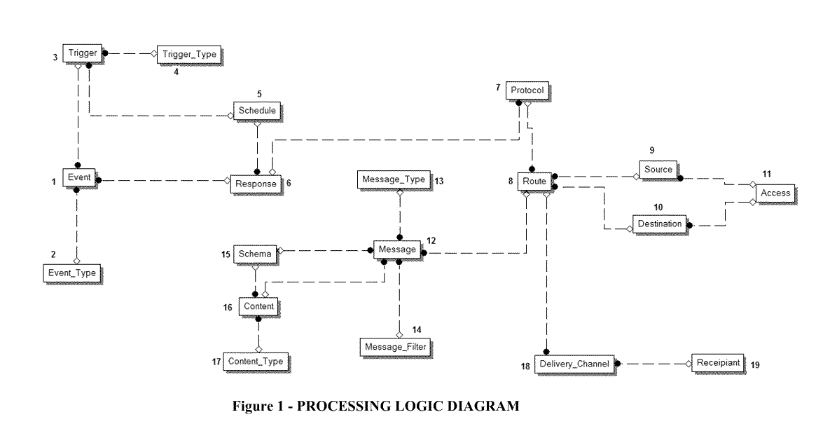

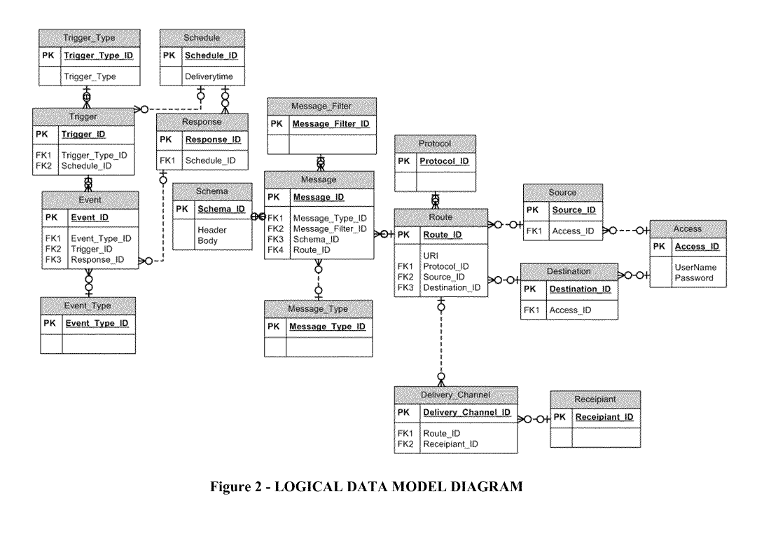

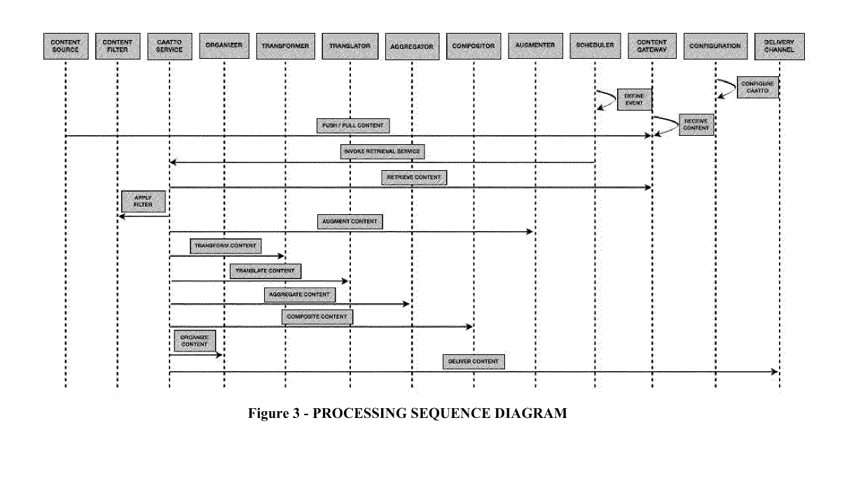

### BRIEF DESCRIPTION OF THE DRAWINGS

| FIG. # | Drawing Title/Description | Page # |
|---|---|---|
| FIG. 1: | PROCESSING LOGIC DIAGRAM | 11 |
| FIG. 2: | LOGICAL DATA MODEL DIAGRAM | 12 |
| FIG. 3: | PROCESSING SEQUENCE DIAGRAM | 13 |

### DETAILED DESCRIPTION OF EXEMPLARY EMBODIMENTS

With respect to exemplary methods, apparatus, and products for its unique intelligent event-driven processing: this invention provides a practical and readily available means to enable only the delivery of desired content from text and rich media data sources, scheduled specifically to be delivered when desired, and intelligently filter out unwanted content—all defined by intelligent contextual relevance, and driven by human interaction with energy management. This invention's processing engine solution provides a powerful utility service design that minimizes the amount of storage required for persisting messages, filters out unwanted messages, and organizes text, email, and voice mail messages into a common delivery channel, enabling content aggregation, augmentation, and transformation into a concerted and organized presentation. This smart grid contextual relevance-based message processing engine solution can be easily configured, adopted, and readily used by consumers in accordance with the present invention, as described with reference to the accompanying drawings (FIGS. 1-3).

Below is a descriptive example of the operating environment and interactions of this invention's internal processing:

Process Components—Definitions
1.-4. Event—Energy Management interactions which serve as CAATTO intelligent process initiators.
5. Schedule—Contextual message delivery timing queue.
6. Response—Action taken by CAATO as result of an event.
7. Protocol—Communication means to access messages.
8. Route—Identifies path from source(s) to destination(s).
9. Sources—Origination of message content.
10. Destination—Intended location of content delivery.
11. Access—Security and integration pattern to source data or destination storage.
12. Message—Message content.
13. Message_Type—Text, email, or voice mail message.
14. Message Filter—Applies template to filter and structure response format.
15. Schema—Hierarchical structure for templates for message type.
16. Content—Message content used for augmentation.
17. Content_Type—Structured or unstructured media types.
18. Delivery Channel—Defined delivery path.
19. Recipient—Receipt of message content by CAATTO.

Process Sequences
1.-4. Event is triggered by CAATTO to retrieve messages (voice, email, text)
5. Schedule—Content delivery event is scheduled.
6. Action is initiated by CAATO as result of an event.
7. Protocol—communication means is identified to access messages.
8. Route—identifies the path from source(s) to destination(s).
9. Sources—Identify the Source of message content.
10. Destination—Identify the intended location for content delivery.
11. Access—Identify security and integration pattern to source data or destination storage
12. Message—Identify message content
13. Message_Type—Identify text, email or voice mail message.
14. Message Filter—Applies template to filter and structure response format.
15. Schema—Identify hierarchical structure for templates for message type.
16. Content—Identify Content used to augment messages.
17. Content_Type—Identify structured or unstructured media type(s).
18. Delivery Channel—Identify defined delivery path.
19. Recipient—Receipt of message content by CAATTO.

What is claimed is:

1. This invention offers an exponential capability to the smart grid, by enabling the means to seamlessly integrate the intelligent processing and delivery of contextually relevant messaging based upon the consumers' interaction with energy management.

2. This invention organizes message from separate text, email, and voice mail channels, and flows into a common delivery channel for consumption based upon human interaction with energy management.

3. This invention enables the formation of content transformation into an organized presentation.

4. In support of claim 1, this invention provides a powerful utility service design for the smart grid that minimizes the amount of storage required for persisting messages.

5. In support of claim 1, this invention intelligently filters out unwanted messages.

6. In support of claim 1, this invention delivers message-type content on demand, and scheduled based upon the user's contextually relevant preferences.

7. In support of claim 1, this invention only delivers the select content identified for consumption—via scheduled, or on demand service—based upon contextual relevance.

8. In support of claim 2, this invention routes and delivers content through the requested delivery channel.

9. In support of claim 2, this invention provides a common gateway to multiple message frameworks currently in existence and available in the marketplace.

10. In support of claim 3, this invention enables content aggregation into a standard organized presentation.

11. In support of claim 3, invention enables content composition into a standard organized presentation.

12. In support of claim 3, invention enables content augmentation into a standard organized presentation.

13. In support of claim 3, invention can be used effectively as a bi-directional retrieval, transformation and delivery engine—on either end or both sides of: a content management system; post office; voice mailbox, or; process workflow, search, or decision engines—wherever datastreams' input or output integration capabilities exist.
